(19) United States
(12) Patent Application Publication
(10) Pub. No.: US 2017/0144003 A9
(43) Pub. Date: May 25, 2017

(54) FIRE RETARDATION MISSILE SYSTEM AND METHOD

(71) Applicant: Byron J. Willner, Hot Springs, VA (US)

(72) Inventor: Byron J. Willner, Hot Springs, VA (US)

(21) Appl. No.: 14/580,104

(22) Filed: Dec. 22, 2014

Related U.S. Application Data
(63) Continuation-in-part of application No. 12/590,535, filed on Nov. 12, 2009, now abandoned.
Application No. 12/590,535 is a continuation of application No. 12/061,634, filed on Apr. 2, 2008, now abandoned.

(51) Int. Cl. A62C 3/02; A62C 37/00

(52) U.S. Cl. CPC A62C 3/025; A62C 37/00

(57) ABSTRACT

A fire retarding missile and method of use having a unitary construction and containing a propulsion system as well as fire treatment materials. Dispersal of the materials can be initiated both actively and passively, with passive dispersal allowing for a fail safe mode of operation. The fire treatment materials are of the oxygen reduction type, and the method of the invention is to target the hot spot of a fire in order to reduce the spread and intensity thereof. An active guidance system may be of the heat seeking type, or may alternatively be remote controlled video. Stabilizer and guidance fins are controlled in response to signals from the guidance system in order to precisely position the device. In one embodiment, the device can be broken down to allow for easy replacement of certain components. The device can be modified for use in fires of specific heat ranges by using nose cones designed to melt in a respective heat range.

### CROSS REFERENCE TO RELATED APPLICATION

This application is a continuation in part of application Ser. No. 12/590,535 filed Nov. 12, 2009, which is a continuation of application Ser. No. 12/061,634, filed Apr. 2, 2008.

### BACKGROUND OF THE INVENTION

The present invention relates generally to fire extinguishing methods and apparatus. More specifically, the invention relates to a fire retardant missile which can be targeted to a specific location to suppress or eliminate combustion of a target fire.

### Statement of the Prior Art

Firefighting techniques have evolved over the years to take advantage of advances in technology to more efficiently control fires. It is well known that the particular technique or device used to control or extinguish a fire is dictated primarily by two factors, namely, the location and area covered by the fire, and the combustible material involved. For certain chemical fires it is well known that water is not particularly effective for extinguishing the fire, though it may be useful for controlling the spread of the fire to adjacent combustible materials. For forest or other large area fires water is effective generally, but vast amounts are required and delivery to remote areas can be difficult if not dangerous.

In recent years it has been discovered that devices containing various types of flame retardant and/or extinguishing materials may be delivered to the source of a fire to control the spread of the fire. These devices are entirely passive, in that they react to local temperatures at the delivery site, the reaction invariably involving a rupturable membrane which allows for explosive dispersal of the fire treating material.

Typical of these devices is that disclosed in U.S. Pat. No. 7,121,354 issued to one Munson, Jr. for a fire treating device and method. The device is an elongated cylinder of the rupturable membrane type as described above, which can be delivered by cannon, by rolling or throwing, or by glider or missile. The Munson device suffers from the drawback in that it can only be passively detonated, and is not sufficiently aerodynamic to ensure accurate placement regardless of the delivery method.

### SUMMARY OF THE INVENTION

The present invention overcomes the disadvantages of the prior art by providing a fire retarding missile and method of use having a unitary construction and containing a propulsion system as well as fire treatment materials. Dispersal of the materials can be initiated both actively and passively, with passive dispersal allowing for a fail-safe mode of operation. The fire treatment materials are of the oxygen reduction type, and the method of the invention is to target the hottest point of a fire in order to reduce the spread and intensity thereof An active guidance system may be of the heat seeking type, or may alternatively be remote controlled video. Stabilizer and guidance fins arc controlled in response to signals from the guidance system in order to precisely position the device.

The purpose of the Fire Retardant Missile is to reduce the amount of oxygen fires need to continue unchecked combustion. Examples of typical situations include forest fire hot spots, the center of a burning building, or an oil fire. Any of these fire conditions can and usually do initially expand uncontrolled.

The primary object of the invention is to aid the fire fighters in reducing a fire to a controllable level. The inventive device is designed to be manufactured with minimal cost, to be readily available for use by moderately trained personnel, and to present minimal requirements for integration into present day support equipment.

Accordingly, it is an object of the invention to provide a fire retardant missile system which overcomes the disadvantages of the prior art.

It is another object of the invention to provide a fire retardant missile that can be both passively and actively detonated.

It is another object of the invention to provide a fire retardant missile which can be operated in a fail safe mode when deployed for active detonation.

It is another object of the invention to provide a fire retardant missile which is of unitary construction.

It is another object of the invention to provide a fire retardant missile which has a self contained propulsion system.

It is another object of the invention to provide a fire retardant missile system which has an electronic guidance system.

It is another object of the invention to provide a fire retardant missile system which has multiple nose cone covers or other heat sensing devices, each of which are selected to melt at a predetermined temperature dependent upon fire intensity.

The construction of the device would be largely nonmetallic. The device includes a nose cone, a nose cone cover surrounding the nose cone, heat sensitive retardant release mechanism, impact trigger, a fire retardant material reservoir of made of spun fiber, fire retardant material, fire retardant release valves, an outer shell of reinforced plastic, and other components as will be explained in more detail later. A battery and electronics for operating the device in various modes also form part of the invention.

The fire retardant material release valves are molded into the fire retardant reservoir of spun fiber and constructed with an electro solenoid, a solenoid plunger stop slot, a solenoid plunger, a solenoid plunger stop trigger, a solenoid plunger stop trigger spring, fire retardant vent slots, a positive or hot wire, thermostatic control switch, and an external positive contact for positive battery power.

### BRIEF DESCRIPTION OF DRAWINGS

FIG. 1 is a cross section of the fire retardation missile device of the invention.

FIG. 2 is a cross section of the fire retardation missile enhanced with video camera.

FIG. 3 is a cross section of the fire retardation missile enhanced with heat seeking guidance system.

FIG. 4 is a cross section of the fire retardant release valves of the fire retardation missile with the solenoid plunger in the closed position.

FIG. 5 is a cross section of the fire retardant release valves with the solenoid plunger in the open position.

FIG. 6 is a cross section of an alternative embodiment of the fire retardant.

FIG. 7 is the cross section of the fore and aft sections with electrical connections.

FIG. 8 is the cross section of the fore and aft section mating.

### DETAILED DESCRIPTION OF THE INVENTION

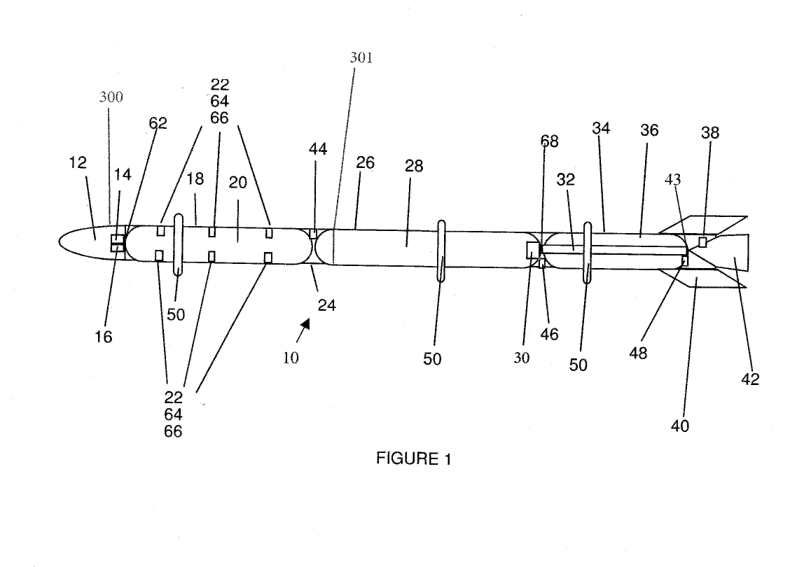

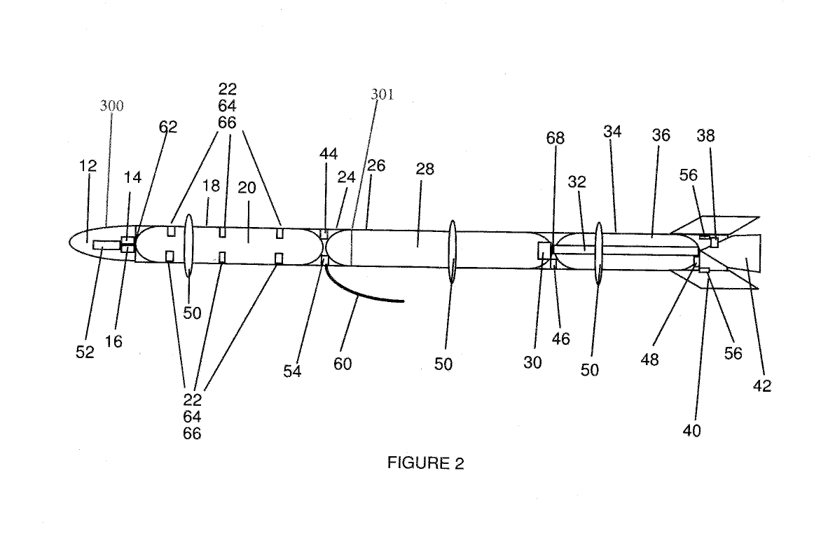

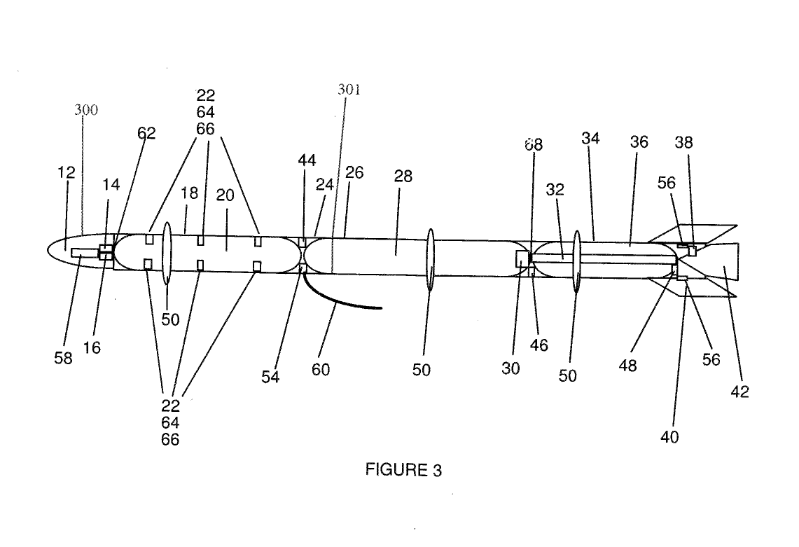

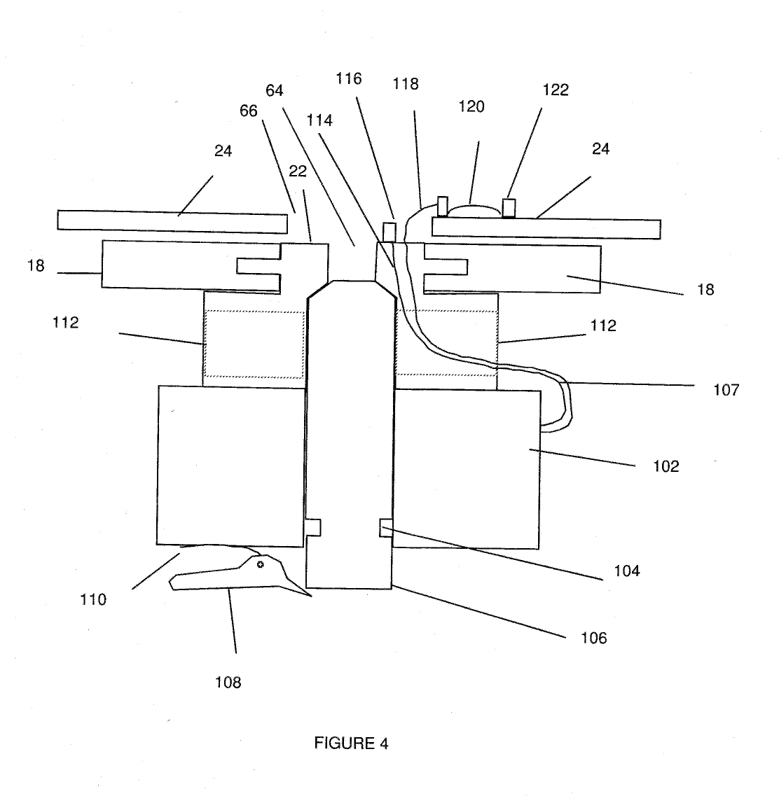

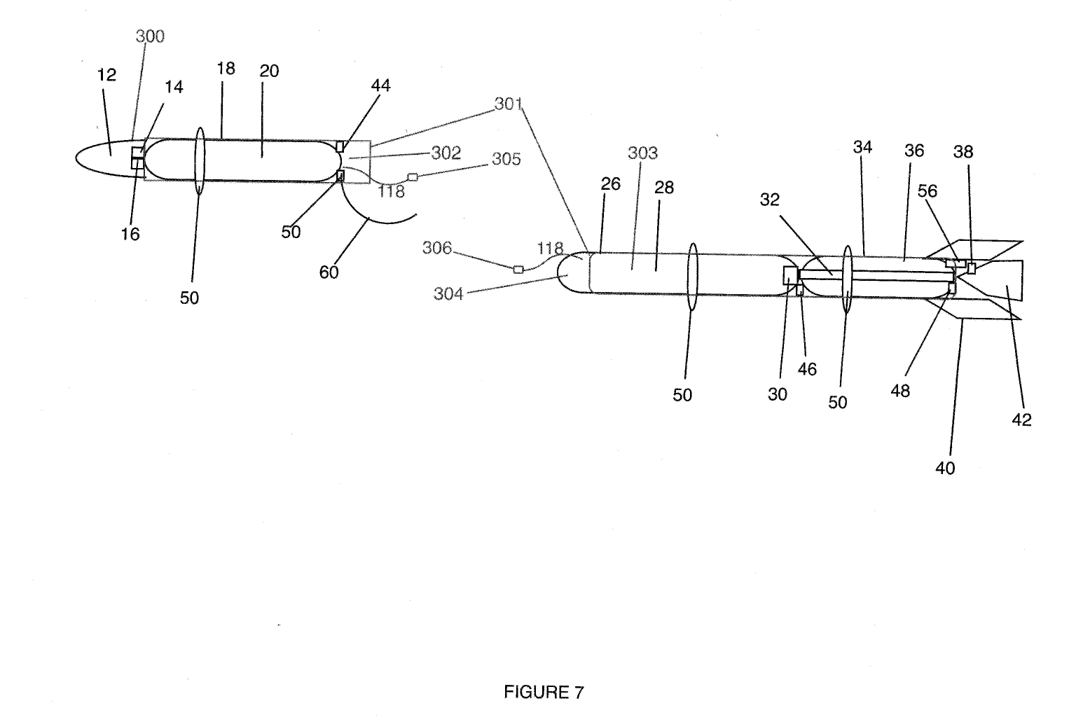

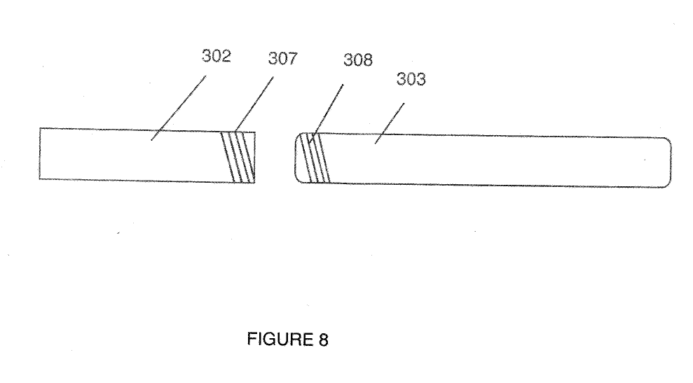

Referring now to FIGS. 1-8 the device of the invention, generally indicated by the numeral 10 is shown. The device 10 generally includes as a unitary construction, a fire treating materials container or reservoir 18, compressed air or secondary propellant container 26, a valve arrangement 14, 22 having various mechanisms to effect release and dispersion of the fire treating materials in response to a plurality of predetermined conditions as will be described in more detail below, and a solid fuel container 34, all contained within a streamlined, aerodynamic, generally cylindrical housing 24 which includes a nose cone assembly 12 at its forward end, the assembly 12 surrounded by a nose cone cover 300. It is to be understood that the device 10 suitably includes some of these components, all of these components, additional components, or a mixture thereof. Additionally, the components need not be present as a unitary construction and alternatively are suitably provided as a number of separately manufactured components. In a preferred embodiment, most of the major components, including the housing 24, reservoir 18, container 26, and valve arrangements 14, 22 are to be fabricated from nonmetallic components to reduce weight and cost. Various types of hardened plastic materials can be used as would be apparent to one of skill in the art.

The nose cone cover 300 can be made of any high temperature nonmetallic material such as, Polyethylene Terephthalate, High Density Polyethylene, Vinyl (Polyvinyl Chloride or PVC), Low Density Polyethylene, or any material which can be manufactured to reliably melt or decompose within a selected temperature range. Thus, it is a key aspect of the invention to provide for the device 10 a nose cone cover 300 which melts at a predetermined temperature depending upon the intensity of the fire to which it is applied. In a first passive mode, the nose cone cover 300 melts allowing the heat sensing components of the valve mechanisms 14, 22 to trigger the release of fire retardant materials 20 contained within container 18, with valve mechanisms 22 also triggered as will be explained below. In a second passive mode, valve mechanism 14 includes an impact trigger. In an active mode, the device 10 may include a video camera or other electronic sensing devices which allow an operator to detonate the device 10 based upon visually obtained information as will be explained in more detail below.

The melting point of the nose cone cover 300 would depend on the status of the fire. Generally, a low level fire may require a melting point of just above 300 but less than 600 degrees Fahrenheit. Areas of low-level fires generally have a flame temperature of approximately 680 degrees Fahrenheit. The cone cover 300 must melt or disintegrate with sufficient amount of time to allow activation of the heat sensitive valve mechanism 14, 22 which releases the fire retardant material 20 contained within container 18. A high level fire with intensely high temperature or hot spots may require a melting point of 1000 degrees Fahrenheit as high-level fires generally have a flame temperature of approximately 1480 to 1680 degrees Fahrenheit. An intermediate level of fire intensity would require a melting point of between 600 and 1000 degrees. Preferably, it is a key aspect of the invention to have at least three temperature ranges for the nose cone cover 300, which is attachable to the front end of the housing 24 via a locking mechanism which may be a bayonet type arrangement or any other type of arrangement as would be apparent to one of skill in the art. Given the fire intensities as discussed above, three nose cones 12 units may be supplied with each missile 10. The nose cone covers 300 of the three nose cones 12 may have melting points of 300, 700, and 1000 degrees F., respectively, and be appropriately labeled, allowing the user to attach the appropriate nose cone cover 300 based upon the measured or estimated temperature of the fire to be treated.

The fire retardant materials reservoir 18 is of a generally cylindrical shape and includes an opening 62 formed at the forward end which is sealed by valve mechanism 14. Additional valve mechanisms 22 are arranged in four regularly spaced rows on the reservoir 18 sidewalls, with each valve 22 having a corresponding opening 64 formed in the reservoir 18 sidewalls so that the valve 22 can allow the contents of the reservoir 18 to disperse therethrough. Housing 24 has corresponding openings 66 formed therein, the outlet end of the valves 22 flush mounted therewith to maintain the aerodynamics of the device 10. The arrangement of valves 14, 22 allows the fire retardant material 20 to be dispersed in a radial or spherical pattern as would be apparent to one of skill in the art. The reservoir 18 contains the fire retardant material 20 which is preferably a halogen material. Such fire retardant material 20 is also suitably one or more of the following nonexclusive list: dry chemical foam, dry chemical powder, sodium bicarbonate, potassium bicarbonate, purple-K, mono ammonium phosphate, halon 1211, etc. It is to be appreciated that any suitable fire fighting material as known in the art is suitably used with the fire extinguishing device 10. The reservoir 18 is pressurized with nitrogen to enable the material 20 to be expelled and dispersed in a large radius when the valve mechanism 14, 22 is activated.

The fire retardant release valves 14, 22, are molded into the fire retardant reservoir 18 in fluid tight relation with openings 64 and 62 so as to selectively allow the flow of fire retardant material therethrough. Each of the valves comprises an electro solenoid 102, solenoid plunger stop slot 104, solenoid plunger 106, solenoid plunger stop trigger 108, solenoid plunger stop trigger spring 110, fire retardant vent slots 112, positive or hot wire 118, thermostatic control switch 120, and external positive contact 122 for positive power from battery 46.

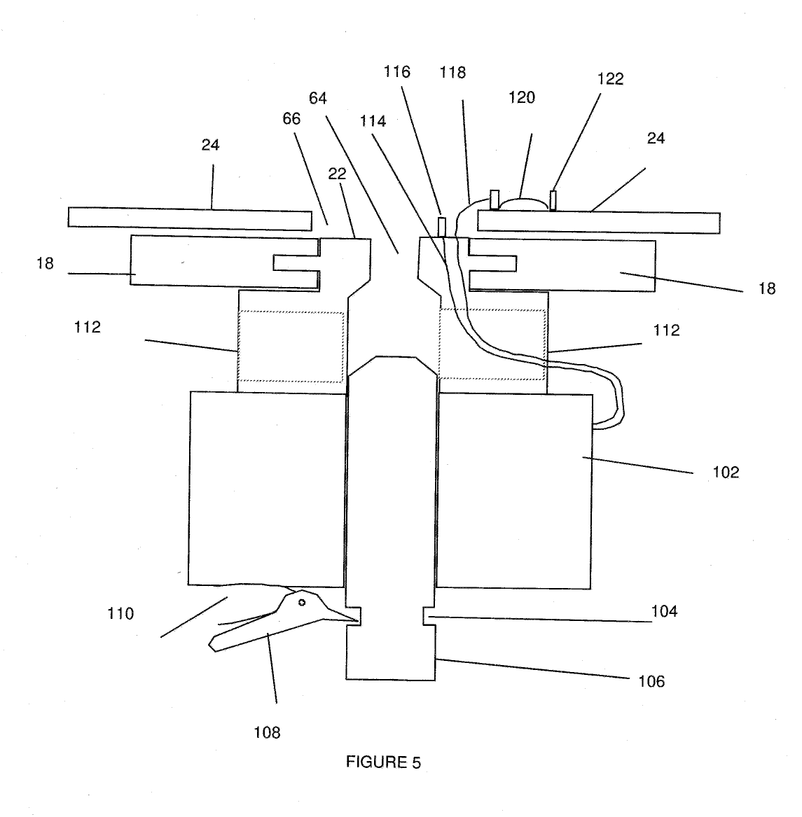

The valve mechanisms 14, 22 are heat sensing and are constructed in such a manner that when positive power is applied to the external positive contact point 122 and heat is sensed at the thermostatic control switch 120, the thermostatic control switch 120 will close providing power to activate the electro solenoid 102. The activation of solenoid 102 moves the solenoid plunger 104 axially to the open position (FIG. 5) whereupon it is locked in the open position by the solenoid plunger stop trigger 108 and held in place by the solenoid plunger stop trigger spring 110. The retardant material 20 is then forced out of the vent slots 112 and out into the fire zone. The forward battery 44 provides power for the forward electronics to operating the forward heat detection array and through the thermo switch's 46 providing voltage to the electro solenoids when the thermal switches are activated.

A key aspect of the invention is a two-stage propulsion system which enhances reliability and increases the range of the device 10. Accordingly, a solid fuel container 34 is employed in combination with compressed air container 26 to provide for the alternate expulsion of hot gasses or compressed air through exhaust nozzle 42 via orifice 43 to provide motive force for the device 10. The solid fuel container 34 has a compressed air conduit 32 positioned and directed axially therethrough to allow for fluid communication between the compressed air container 26 and the aft exhaust nozzle 42 as will be explained in more detail below. The compressed air container 26 has an open aft end 68 which is selectively sealed by a valve arrangement 30. The compressed air or nonflammable gas contained within container 26 is released under predetermined conditions by valve 30 which is activated electronically, with power provided by the forward battery 44, by an accelerometer and heat detection sensor trigger 38 positioned in the engine nozzle 42 area, the trigger configured in a known arrangement as would be familiar to one of skill in the art. Specifically, when the solid fuel 36 stored within container 34 is depleted and heat is no longer sensed at the engine nozzle 42, compressed air (or other compressed gas) is released from container 26, into and through conduit 32, and out through nozzle 42, by valve 30 in response to control signals from trigger 38. It should be noted that if the compressed gas is an inert gas like nitrogen, the gas in the container 26 would act as an additional fire suppressant as it would temporarily deprive the fire of oxygen. A combination of any suitable commercially available heat sensor and accelerometer units 38 may be employed, as would be apparent to one of skill in the art, propelling the device 10.

Ignition of the solid fuel 36 is initiated by a solid rocket fuel igniter 48, which supplies power via the circuit formed from the launch switch (not shown but part of a standard re-usable launch platform), battery 46, and aft and mid launch rings 50.

The device 10 has spring-loaded fins 40 for guidance stability and containment in a launch tube. When the nose cone cover 300 melts, exposing the heat sensitive retardant release valve 14 and impact trigger 16, and impact is imminent, and if the heat sensitive retardant release valve 14 fails to activate the fire retardant release valves 14, 22, the impact trigger 16 becomes the primary fire retardant release mechanism. Thus, if the nose cone 12 does not melt, the impact trigger 16 functions as a backup retardant release mechanism.

In an alternative embodiment, the device 10 includes a fore 302 and aft 303 section which are releasably attached at connection point 301. The fore section 302 contains the nose cone 12, sensors 16, 18, fire retardant material, and other control mechanisms as previously described, while the aft section 303 contains a pressurized canister 304 which may contain oxygen or an inert gas. The canister 304, which replaces canister 26 in the previous embodiment, is of a standard size so as to be interchangeably used with a standard firefighter oxygen unit. The open end of aft section 303 (when the sections 302, 303 are disassembled) allows access to canister 304. Thus, in the field, the canisters 304 may be used as an additional supply of oxygen by simply removing them from the device 10. Conversely, if a canister 304 is damaged or leaking it can be replaced by a viable canister removed from a standard oxygen unit thereby providing redundancy and enhancing reliability. Fore section 302 electrical male plug 305 and aft section 303 electrical female plug 306 may be of a quick disconnect or twist lock type. Fore 302 and aft 303 sections may be threaded so that the fore section 302 has female threads 307 capable of receiving the aft section 303 threads 308. Other methods of connecting fore and aft sections may be used as would be apparent to one of skill in the art. The electrical contacts 305, 306 allow for the selective activation of the valve 309 which allows pressurized oxygen to exhaust from the canister 304 in the same manner as canister 26 described above.

Launch facilities may be one of several types such as air vehicle launch tubes or a hang and dropdown arrangement, handheld for smaller devices, ground stabilized mortar type launch tubes or other artillery, mobile vehicles, and water craft. In the event that the device 10 is launched from a launch tube (not shown) launch tube rings 50 are attached to the device 10 in a manner well known to those of skill in the art. The aft and mid launch tube ring 50 have circuit wire connected to the battery 46 such that the aft ring 20 is connected to the solid rocket fuel igniter 48, and the mid launch tube ring is connected to the battery 46.

In operation, a suitable launch platform including a launch tube (not shown) is preferably used. An operator will select a nose cone cover 300 for the device 10 based upon the measured or estimated temperature of the fire to which it is directed as described above. The device 10 is held in place by the launch tube rings 50, the mid launch tube ring 50 acting as the grounding ring that connects all the metallic equipment together, thereby reducing static voltage potential differences. Closing a launch switch (not shown) closes the power circuit of the solid rocket fuel igniter 48, thereby igniting the rocket fuel, and initiating flight of the device 10. Alternatively, when the launch platform is a drop type as it would be from some aircraft, the device 10 will be held in place by clamps on the aircraft clamping the launch tube rings 50. The ignition closure switch will simultaneously release the device 10. Device 200 is launched as described below.

When the device 10 is launched, at the end of the burn time of the solid fuel 36, the accelerometer or heat detection sensor trigger 38 will sense reduction in speed and/or heat that will trigger the compressed air release valve 30. The compressed air 28 will then propel the device 10 to its destination. Since the compressed air canisters 26, 304 may be interchangeably used with the device 10 or a standard fireman's oxygen unit, an air canister may be taken from the oxygen unit to propel the device 10 if necessary.

The compressed air reservoir 26 and fire retardant container 18 may be sensitive to extensive time in the heat zone. These containers, preferably being made of spun fiber and resin, disintegrate after the depletion of the retardant material 20. In the event the reservoir 26 and container 18 disintegrate before full depletion through the designed means, the container 18 will expel the retardant material in an explosive manner due to the compressed gas contained therein. The compressed air container 26 disintegration will have little effect on the fire as it is also filled with nitrogen.

Guidance of the device may be further enabled by the addition of a video camera 52 in the nose cone 12 that will allow the air launch operator to identify the hot spot of the fire from the device 10 through a monitor receiver in e.g. an aircraft. The device 10 will transmit this data from its transmitter/receiver equipment 54 via antenna 60. The launch operator will be able to provide guidance assistance to the device, using any suitable servo system 56 which is integrated into the housing 24 of the device 10 in the well known manner, and the stabilizer fins 40.

Guidance of the device may be further aided by the addition of a heat seeking guidance system 58, as is well known in the art, the specifics of which are not a part of this invention. The heat seeking guidance system 58 will identify the area of greatest heat and assist guidance of the device 10, using servo system 56 and the stabilizer fins 40.

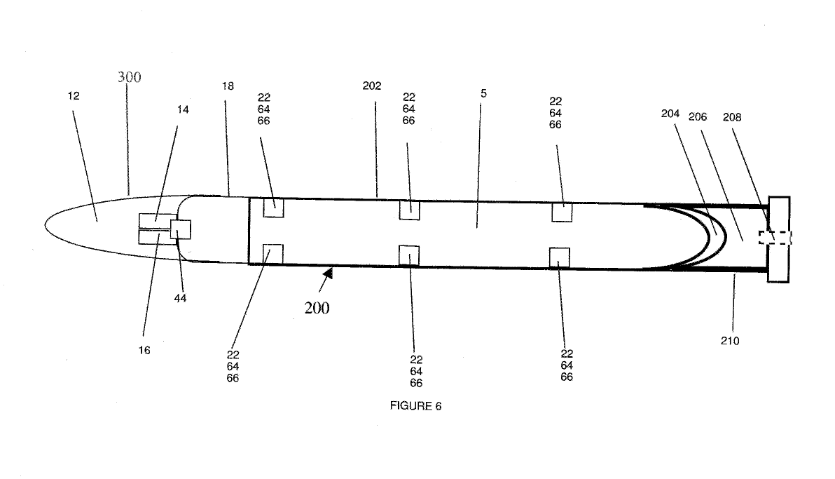

An artillery device 200 based arrangement is shown in FIG. 6. This configuration is similar to the embodiments shown in FIGS. 1-3, except that in lieu of rocket fuel, compressed air, and the corresponding nozzle arrangement, the device 200 is designed to be launched from a recoilless rifle such as a 57, 75 or 108 mm recoilless rifle. The device 200 includes a primer 208 positioned centrally of the rear end, the primer providing a spark for a quantity of gunpowder 206 which is positioned and contained within the device 200. Impact absorbing material 204 such as flame resistant foam is positioned between the gunpowder 206 and canister 202 of the device 200. The device 200 is launched by aiming the rifle (not shown) and using primer 208 to ignite the gunpowder 206.

When the device 10, 200 nears the destination point, heat from the fire melt the nose cone cover 300, exposing the heat sensitive retardant release 14 and the impact trigger 16 causing the retardant material 20 to be released. In the event of the device 10, 200 reaching its destination before the nose cone cover 300 has melted, the impact trigger 16 impacting a firm surface will cause the release of the retardant material 20.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1-12. (canceled)

13. A fire retarding missile system comprising: an elongated, substantially cylindrical main housing section with a longitudinal axis and having a front end and an open end, said housing section including a propulsion mechanism operative to effect thrust at said open end causing acceleration of said missile at least in a direction along the longitudinal axis thereof;
three nose cones, each of said nose cones selectively and independently attachable to said front end of the housing section, where one of said nose cones is attached in response to a predetermined condition, each of said nose cones having a different melting point and each having an impact trigger and a heat sensitive trigger mounted inside, and each of said nose cones having three passive and one active dispersal activation means, said active activation means including a video camera and transmitter means, said video camera and transmitting means allowing an operator to visually determine when to manually activate said active dispersal means;
a container of fire retardant material positioned within said housing immediately adjacent said front end; said propulsion mechanism having at least two modes of generating motivating thrust.

14. The system of claim 13 wherein one of said passive dispersal activation means is said heat sensitive trigger, said heal sensitive trigger allowing dispersal of said fire retardant material through a series of apertures in fluid communication with a heat sensing valve.

15. The system of claim 13 wherein one of said passive dispersal activation means is said container of fire retardant material, where said container is heat sensitive and disintegrates at a predetermined temperature.

16. The system of claim 13 wherein one of said passive dispersal activation means is said impact trigger.

17. The system of claim 13 wherein a first nose cone is provided to melt at temperatures of about 300 degrees Fahrenheit.

18. The system of claim 13 wherein a second nose cone is provided to melt at temperatures of about 600 degrees Fahrenheit.

19. The system of claim 13 wherein a third nose cone is provided to melt at temperatures of about 1000 degrees Fahrenheit.

20. The system of claim 13 wherein each of said video cameras and transmitters are used to transmit imaging telemetry to an operator.

21. The system of claim 14 where said heat sensitive trigger includes a thermostatic control switch.

22. A fire retarding missile system comprising: an elongated, substantially cylindrical main housing with a longitudinal axis and having a fore section and an aft section with an open end, said housing including a propulsion mechanism operative to effect thrust at said open end causing acceleration of said missile at least in a direction along the longitudinal axis thereof;
a nose cone releasably attachable to said fore section of the housing section and having three passive and one active dispersal activation means, said active activation means including a video camera and transmitter means;
a container of fire retardant material positioned within said housing;
said propulsion mechanism including a removable compressed air canister formed of a similar heat sensitive material;
whereby disintegration of said compressed air container has minimal effect on dispersal of said fire retardant material.

23. The system of claim 22 wherein said passive means include an impact trigger and a heat sensitive trigger.

25. The system of claim 22 wherein said aft section is detachable from said fore section and includes the removable air canister.

26. The system of claim 25 where said removable canister is of a standard size for a fireman's oxygen unit, and said aft section includes an interior void sized to contain said standard size canister.
